(19) United States
(12) Patent Application Publication
(10) Pub. No.: US 2026/0152157 A1
(43) Pub. Date: Jun. 4, 2026

(54) BRAKE APPARATUS AND METHOD OF CONTROLLING THE SAME

(71) Applicant: HL MANDO CORPORATION, Pyeongtaek-si (KR)

(72) Inventor: Seongnam KIM, Pyeongtaek-si (KR)

(73) Assignee: HL MANDO CORPORATION, Pyeongtaek-si (KR)

(21) Appl. No.: 19/282,057

(22) Filed: Jul. 28, 2025

(30) Foreign Application Priority Data
Dec. 3, 2024 (KR) 10-2024-0177625

(51) Int. Cl. B60T 8/1755

(52) U.S. Cl. CPC B60T 8/17551; B60T 8/17552; B60T 2250/03; B60T 2260/024; B60T 2270/404

(57) ABSTRACT

A brake apparatus includes brake modules on the left and right wheels of the first and second axles and a controller that sets a target braking torque for each wheel based on a pedal sensor signal and controls each module accordingly, and, upon detecting a failure in one or more brake modules, identifies a yaw rate error between the target and current yaw rates using a motion sensor signal, distributes additional braking torque to the operational modules based on the yaw rate error, and adjusts their braking torque based on both the target and additional values.

### CROSS-REFERENCE TO RELATED APPLICATIONS

This application claims the priority of Korean Patent Application No. 10-2024-0177625 filed on Dec. 3, 2024, in the Korean Intellectual Property Office, the disclosure of which is incorporated herein by reference.

### BACKGROUND

### Field

The disclosed disclosure relates to a brake apparatus and a method of controlling the same.

### Description of the Related Art

A vehicle is essentially equipped with a brake system for braking the vehicle. Various types of brake systems have been proposed to obtain a stable, effective braking force.

A general brake system includes a disc configured to rotate together with a vehicle wheel, a caliper having a pair of pad plates installed to be advanced or retracted to press the disc, and a piston installed to be slidable relative to the caliper. The general brake system mainly implements braking of a wheel cylinder by allowing brake oil to press the piston against the disc when a driver presses a brake pedal.

However, recently, as there has been an increasing demand from the market to implement various braking functions in order to appropriately cope with operational environments of vehicles, a technology has been developed that electromechanically generates a braking force by utilizing a motor and various types of gear structures by receiving the driver's braking intention as an electrical signal when the driver presses the brake pedal.

The brake system includes electromechanical brakes respectively mounted in four wheels of the vehicle and configured to operate independently. Therefore, if any one of the four electromechanical brakes of the brake system malfunctions and the remaining wheels operate normally without considering the malfunction, the vehicle rapidly tilts toward one side, such that the vehicle cannot be normally braked, or an accident may occur.

### SUMMARY

An object of the disclosed disclosure is to provide a brake apparatus capable of stably and effectively braking a vehicle by preventing the vehicle from tilting in a braking situation in which any one of electromechanical brakes respectively provided in a plurality of wheels of the vehicle malfunctions, and a method of controlling the same.

A brake apparatus according to one aspect of the disclosed disclosure may include: a plurality of brake modules respectively provided in left and right wheels on a first axle of a vehicle; a plurality of brake modules respectively provided in left and right wheels on a second axle of the vehicle; and a controller configured to set target braking torque for each wheel based on an output signal from a pedal sensor provided in the vehicle and control braking torque of each of the plurality of brake modules based on the target braking torque for each wheel, in which the controller is further configured to: identify an occurrence of a yaw rate error between a target yaw rate and a current yaw rate of the vehicle based on an output signal of a motion sensor provided in the vehicle upon identifying a failure of at least one of the plurality of brake modules is identified; distribute additional braking torque for each wheel to an operational brake module based on the yaw rate error; and control braking torque of the operational brake module based on the target braking torque for each wheel and the additional braking torque for each wheel.

The controller may be further configured to: identify an additional braking torque distribution variable including at least one of a position of a failed brake module, where the failure is identified, a traveling direction of the vehicle, and a traveling motion of the vehicle; and distribute the additional braking torque for each wheel to the operational brake module based on the additional braking torque distribution variable.

The controller may be further configured to: acquire the additional braking torque for each wheel by acquiring redistribution braking torque based on the target braking torque for each wheel and the failed brake module, compare moment-arms for the operational brake module based on the additional braking torque distribution variable, and distribute the redistribution braking torque based on a result of comparing the moment-arms.

The controller may be further configured to: assign a negative (−) or positive (+) first sign to each of the position of the failed brake module, the traveling direction of the vehicle, and the traveling motion of the vehicle; assign a negative (−) or positive (+) second sign to the brake module that is positioned on the same side of any one of the first axle and the second axle as the failed brake module based on a computation of the assigned sign; assign a negative (−) or positive (+) third sign to the brake module that is positioned on the opposite side of the failed brake module based on a computation of any one of the first axle and the second axle to the second sign and the first sign assigned to the traveling motion; and distribute the additional braking torque for each wheel to the operational brake module based on the second sign and the third sign.

The controller may be further configured to distribute additional braking torque for each wheel, which is acquired by increasing or decreasing the redistribution braking torque, to the brake module that is positioned on the same side of any one of the first axle and the second axle as the failed brake module, based on the second sign.

The controller may be further configured to distribute additional braking torque for each wheel, which is acquired by increasing or decreasing the redistribution braking torque, to the brake module that is positioned on the opposite side of any one of the first axle and the second axle to the failed brake module, based on the third sign.

The controller may be further configured to: acquire the additional braking torque for each wheel distributed to the operational brake module based on each of the second sign and the third sign; and distribute the additional braking torque for each wheel, which is acquired by increasing or decreasing the redistribution braking torque, to the brake module that is positioned on on the opposite side of the remaining one of the first axle and the second axle to the failed brake module.

The controller may be further configured to: assign a negative (−) and positive (+) sign to the left and right wheels identified based on the position of the failed brake module, assign a negative (−) and positive (+) sign to left and right turns identified based on the traveling direction of the vehicle, and assign a negative (−) and positive (+) sign to understeering and oversteering identified based on the traveling motion of the vehicle.

Based on the identification of the failure in the brake module provided at the left wheel of the first axle, when a right turn and oversteering of the vehicle are identified, the controller may be further configured to reduce the yaw rate error by distributing the additional braking torque for each wheel of the brake modules provided in the right wheel on the first axle and the left wheel on the second axle, and wherein the additional braking torque is greater than the additional braking torque for each wheel of the brake module provided in the right wheel on the second axle.

Based on the identification of the failure in the brake module provided at the left wheel of the first axle, when a right turn and understeering of the vehicle are identified, the controller may be further configured to reduce the yaw rate error by distributing the additional braking torque for each wheel of the brake module provided in the right wheel on the second axle, and wherein the additional braking torque is greater than the additional braking torque for each wheel of the brake modules provided in the right wheel on the first axle and the left wheel on the second axle.

Based on the identification of the failure in the brake module provided at the left wheel of the first axle, when a left turn and oversteering of the vehicle are identified, the controller may be further configured to reduce the yaw rate error by distributing the additional braking torque for each wheel of the brake module provided in the right wheel on the first axle, wherein the additional braking torque is greater than the additional braking torque for each wheel of the brake modules provided in the left wheel on the second axle and the right wheel on the second axle.

Based on the identification of the failure in the brake module provided at the left wheel of the first axle, when a left turn and understeering of the vehicle are identified, the controller may be further configured to reduce the yaw rate error by distributing the additional braking torque for each wheel of the brake modules provided in the left wheel on the second axle and the right wheel on the second axle, wherein the additional braking torque is greater than the additional braking torque for each wheel of the brake module provided in the right wheel on the first axle.

The controller may be configured to set the target braking torque for each wheel based on a greater value of a required braking torque and an advanced driver assistance system (ADAS)-required braking torque determined by an ADAS function.

Another aspect of the disclosed disclosure provides a method of controlling a brake apparatus, which includes a plurality of brake modules related to braking of left and right wheels on a first axle of a vehicle, a plurality of brake modules related to braking of left and right wheels on a second axle of the vehicle, the method including: setting, by the controller, target braking torque for each wheel for the plurality of brake modules based on an output signal from a pedal sensor provided in the vehicle; identifying, by the controller, an occurrence of a yaw rate error between a target yaw rate and a current yaw rate of the vehicle based on an output signal from a motion sensor provided in the vehicle when a failure of at least one of the plurality of brake modules is identified; distributing, by the controller, additional braking torque for each wheel to the operational brake module based on the yaw rate error; and controlling, by the controller, braking torque of the operational brake module based on the target braking torque for each wheel and the additional braking torque for each wheel.

The distributing of the additional braking torque for each wheel to the brake module by the controller may include: identifying an additional braking torque distribution variable including at least one of a position of a failed brake module, where the failure is identified, a traveling direction of the vehicle, and a traveling motion of the vehicle; and distributing the additional braking torque for each wheel to the operational brake module based on the additional braking torque distribution variable.

The distributing of the additional braking torque for each wheel to the brake module by the controller may further include: acquiring the additional braking torque for each wheel by acquiring redistribution braking torque based on the target braking torque for each wheel and the failed brake module; comparing moment-arms for the operational brake module based on the additional braking torque distribution variable; and distributing the redistribution braking torque based on a result of comparing the moment-arms.

The distributing of the additional braking torque for each wheel to the brake module by the controller may further include: assigning a negative (−) or positive (+) first sign to the position of the failed brake module, the traveling direction of the vehicle, and the traveling motion of the vehicle; assigning a negative (−) or positive (+) second sign to the brake module that is positioned on the same side of any one of the first axle and the second axle as the failed brake module based on a computation of the assigned sign; assigning a negative (−) or positive (+) third sign to the brake module that is positioned on the opposite side of any one of the first axle and the second axle to the failed brake module based on a computation of the second sign and the first sign assigned to the traveling motion; and distributing the additional braking torque for each wheel to the operational brake module based on the second sign and the third sign.

The distributing of the additional braking torque for each wheel to the brake module by the controller may further include: distributing the additional braking torque for each wheel, which is acquired by increasing or decreasing the redistribution braking torque, to the brake module that is positioned on the same side of any one of the first axle and the second axle as the failed brake module, based on the second sign.

The distributing of the additional braking torque for each wheel to the brake module by the controller may further include: distributing the additional braking torque for each wheel, which is acquired by increasing or decreasing the redistribution braking torque, to the brake module that is positioned on the opposite side of any one of the first axle and the second axle to the failed brake module, based on the third sign.

The distributing of the additional braking torque for each wheel to the brake module by the controller may further include: acquiring the additional braking torque for each wheel distributed to the operational brake module based on the second sign and the third sign; and distributing the additional braking torque for each wheel, which is acquired by increasing or decreasing the redistribution braking torque, to the brake module that is positioned on the opposite side of the remaining one of the first axle and the second axle to the failed brake module.

According to one aspect of the disclosed disclosure, it is possible to stably stop the vehicle by preventing the vehicle from tilting in the braking situation when any one of the electromechanical brakes respectively provided in the plurality of wheels of the vehicle malfunctions.

In addition, according to one aspect of the disclosed disclosure, it is possible to stably stop the vehicle by preventing the vehicle from tilting even in the situation in which the braking force of the wheel with a failure is maintained at a predetermined value.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of a vehicle according to an embodiment of the disclosed disclosure;

FIG. 2 is a view illustrating a brake apparatus according to the embodiment of the disclosed disclosure and a configuration of the vehicle related to the brake apparatus;

FIG. 3 is a view illustrating an example of an electromechanical brake according to the embodiment of the disclosed disclosure;

FIG. 4 is a view illustrating an example of a connection relationship between components included in the brake apparatus according to the embodiment of the disclosed disclosure;

FIG. 5 illustrates views of a distribution of additional braking torque for each wheel according to a first embodiment of the disclosed disclosure;

FIG. 6 illustrates views of a distribution of additional braking torque for each wheel according to a second embodiment of the disclosed disclosure;

FIG. 7 illustrates views of a distribution of additional braking torque for each wheel according to a third embodiment of the disclosed disclosure;

FIG. 8 illustrates views of a distribution of additional braking torque for each wheel according to a fourth embodiment of the disclosed disclosure;

FIG. 9 to 12 illustrate views for explaining a sign computation and a distribution of additional braking torque for each wheel according to the first embodiment of the disclosed disclosure;

FIGS. 13 to 16 are views for explaining a sign computation and a distribution of additional braking torque for each wheel according to the second embodiment of the disclosed disclosure;

FIG. 17 is a view illustrating a method of controlling the brake apparatus according to the embodiment of the disclosed disclosure; and

FIG. 18 is a view illustrating detailed processes in FIG. 17.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part,’ ‘module,’ ‘member,’ ‘block’ and the like as used in the specification may be implemented in software or hardware. Further, a plurality of ‘part,’ ‘module,’ ‘member,’ ‘block’ and the like may be embodied as one component. It is also possible that one ‘part,’ ‘module,’ ‘member,’ ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

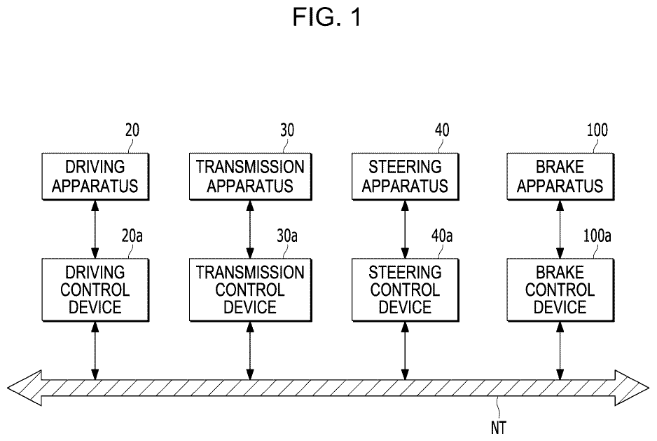

FIG. 1 is a view illustrating a configuration of a vehicle according to an embodiment of the disclosed disclosure.

With reference to FIG. 1, a vehicle 1 may include a driving apparatus 20, a transmission apparatus 30, a steering apparatus 40, and a brake apparatus 100. The driving apparatus 20, the transmission apparatus 30, and the steering apparatus 40 are not essential components, and all or at least some of the above-mentioned components may be excluded. For example, the transmission apparatus 30 may be excluded.

The driving apparatus 20 may provide power for driving the vehicle 1. For example, the driving apparatus 20 may drive or accelerate the vehicle 1 in response to the detection of the driver's acceleration intention inputted through an accelerator pedal.

The driving apparatus 20 may include a motor configured to serve as a driving source for moving the vehicle, and a battery configured to provide energy (electrical energy) to the driving motor that is the driving source. For example, the electric vehicle may include the driving motor as the driving source.

The driving motor may receive electric power from the battery and convert the electrical energy into kinetic energy while the vehicle 1 accelerates. In addition, the driving motor may convert kinetic energy into electrical energy while the vehicle 1 is decelerated or braked. In addition, the driving motor may store the converted electrical energy in the battery. The driving motor may perform regenerative braking in order to decelerate or brake the vehicle.

However, in the driving apparatus 20, a device for recovering energy is not limited to the driving motor. For example, the driving apparatus 20 may selectively further include an alternator. The alternator may convert kinetic energy into electrical energy while the vehicle 1 is decelerated or braked. The alternator may perform regenerative braking in order to decelerate or brake the vehicle.

The driving apparatus 20 may selectively further include an internal combustion engine. For example, a hybrid vehicle may include both the driving motor and the engine as driving sources.

The driving apparatus 20 may include only the motor or may selectively include the motor or the internal combustion engine. In addition, the driving apparatus 20 may not only drive or accelerate the vehicle 1 but also decelerate or brake the vehicle 1 in some instances.

The driving apparatus 20 may include a driving control device 20a configured to control the driving motor. The driving control device 20a may control the driving apparatus 20 in response to the driver's acceleration intention inputted through the accelerator pedal. For example, the driving control device 20a may control a rotational speed and/or torque of the driving apparatus 20. In addition, the driving control device 20a may control regenerative braking by means of the driving motor.

The transmission apparatus 30 may include a plurality of gears and transmit power, which is generated by the driving apparatus 20, to the vehicle wheel.

The transmission apparatus 30 may include a transmission control device (transmission controller (TCU)) 30a. The transmission control device 30a may control the transmission apparatus 30 in response to a transmission instruction of the driver inputted through a gear shift lever and/or a traveling speed of the vehicle 1. For example, the transmission control device 30a may control a transmission ratio from the driving apparatus 20 to the vehicle wheel.

The steering apparatus 40 may change a traveling direction of the vehicle 1. For example, the steering apparatus 40 may steer the vehicle 1 in response to the detection of the driver's steering intention inputted through a steering wheel.

The steering apparatus 40 may include a steering control device 40a. The steering control device 40a may assist an operation of the steering apparatus 40 in response to the driver's steering intention inputted through the steering wheel.

The brake apparatus 100 may provide a braking force for braking the vehicle 1. For example, the brake apparatus 100 may decelerate or stop the vehicle 1 in response to the driver's braking intention inputted through a brake pedal and/or a request of a traveling assistance device.

The brake apparatus 100 may include a braking control device 100a. The braking control device 100a may control the brake apparatus 100 in response to the driver's braking intention inputted through the brake pedal and/or the motion of the vehicle 1.

The driving apparatus 20, the transmission apparatus 30, the steering apparatus 40, and the brake apparatus 100 may perform communication through a vehicle communication network NT such as Ethernet, media-oriented system transport (MOST), Flexray, controller area network (CAN), and local interconnect network (LIN).

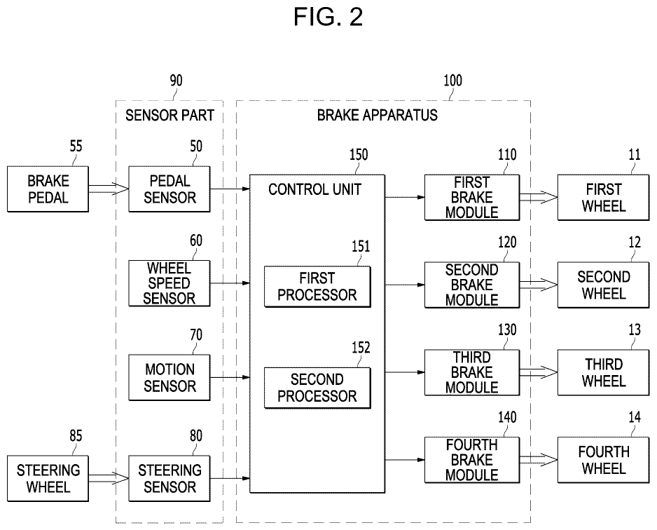

With reference to FIG. 2, the vehicle 1 may include a plurality of wheels 11, 12, 13, and 14 configured to rotate.

For example, the plurality of wheels 11, 12, 13, and 14 may include a first wheel 11 provided at a front left side FL of the vehicle 1, a second wheel 12 provided at a front right side FR of the vehicle 1, a third wheel 13 provided at a rear left side RL of the vehicle 1, and/or a fourth wheel 14 provided at a rear right side RR of the vehicle 1. However, the number of wheels 11, 12, 13, and 14 is not limited to four.

As illustrated in FIG. 2, the vehicle 1 may include a brake pedal 55 configured to acquire an input related to braking from a driver, a pedal sensor 50 configured to detect a movement of the brake pedal 55, a wheel speed sensor 60 configured to detect rotational speeds of the wheels 11, 12, 13, and 14, a steering wheel 85 configured to acquire an input related to steering from the driver, a motion sensor 70 configured to detect a motion of the vehicle 1, a steering sensor 80 configured to detect a rotation of the steering wheel 85, and the brake apparatus 100 configured to provide the plurality of wheels 11, 12, 13, and 14 with braking forces for stopping the vehicle 1. In this case, the pedal sensor 50, the wheel speed sensor 60, the motion sensor 70, and the steering sensor 80 may constitute a sensor part 90. In addition, the pedal sensor 50, the wheel speed sensor 60, the motion sensor 70, and the steering sensor 80 are not essential components, and all or at least some of the above-mentioned components may be excluded. As described above, the sensor part 90 may output signals corresponding to a speed and a motion of the vehicle 1.

The brake apparatus 100 may include a plurality of electromechanical brake (EMB) modules 110, 120, 130, and 140 (hereinafter, referred to as brake modules) respectively installed in the wheels 11, 12, 13, and 14, and a controller 150 configured to control the plurality of brake modules 110, 120, 130, and 140.

The plurality of brake modules 110, 120, 130, and 140 may respectively brake the wheels 11, 12, 13, and 14, thereby braking the vehicle 1. For example, the plurality of brake modules 110, 120, 130, and 140 may include a first brake module 110 configured to brake the first wheel 11, a second brake module 120 configured to brake the second wheel 12, a third brake module 130 configured to brake the third wheel 13, and/or a fourth brake module 140 configured to brake the fourth wheel 14. The number of brake modules 110, 120, 130, and 140 is not limited to four.

The plurality of brake modules 110, 120, 130, and 140 may each be operated in response to a braking signal outputted only from the controller 150 without being mechanically or fluidly connected to the brake pedal 55.

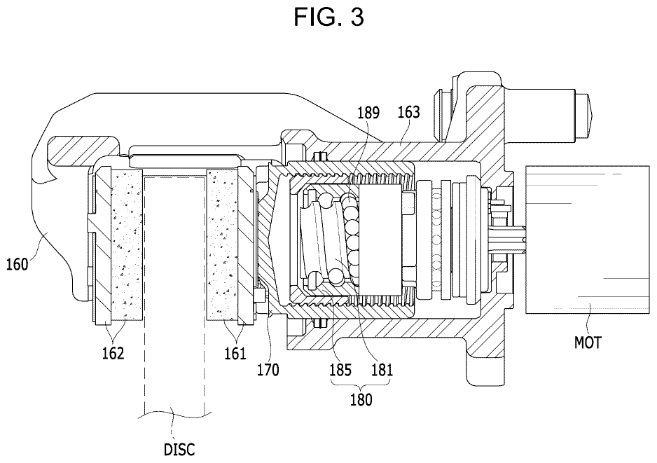

For example, as illustrated in FIG. 3, the plurality of brake modules 110, 120, 130, and 140 may each include a caliper brake.

The caliper brake may include a pair of pad plates 161 and 162 installed to press a brake disc DISC configured to rotate together with the plurality of wheels 11, 12, 13, and 14, a caliper housing 160 configured to operate the pair of pad plates 161 and 162, a piston 170 installed in the caliper housing 160 and configured to advance or retract, a power conversion unit 180 configured to receive rotational driving power for moving the piston 170, convert the rotational driving power into linear driving power, and transmit the linear driving power to the piston 170, and a brake motor MOT configured to generate rotational driving power for moving the piston 170. The pad plates 161 and 162, the caliper housing 160, the piston 170, the power conversion unit 180, and the brake motor MOT are not essential components, and all or at least some of the above-mentioned components may be excluded.

The piston 170 may be provided in a cup shape opened at the rear side (right side in FIG. 3) and sliding movably inserted into a cylinder part 163. In addition, the piston 170 may press the inner pad plate 161 toward the brake disc DISC by receiving power through the power conversion unit 180.

The power conversion unit 180 may include a spindle 181 configured to rotate by receiving driving power from the brake motor MOT, a nut 185 disposed in the piston 170, screw-connected to the spindle 181, and configured to be advanced together with the piston 170 by a rotation of the spindle 181 in a first direction or retracted together with the piston 170 by a rotation of the spindle 181 in a second direction, and a plurality of balls 189 interposed between the spindle 181 and the nut 185. The power conversion unit 180 may be provided as a ball-screw type conversion device configured to convert a rotational motion of the spindle 181 into a linear motion.

A rotational motion of the brake motor MOT may be converted into a linear motion of the piston 170 by the power conversion unit 180. The pair of pad plates 161 and 162 may be compressed toward the brake disc DISC by the linear motion of the piston 170, and the plurality of wheels 11, 12, 13, and 14 may be braked by friction between the pair of pad plates 161 and 162 and the brake disc DISC.

FIG. 3 illustrates the caliper brake as an example of the electromechanical brake. However, the brake is not limited to the caliper brake. For example, the electromechanical brake may include a drum brake.

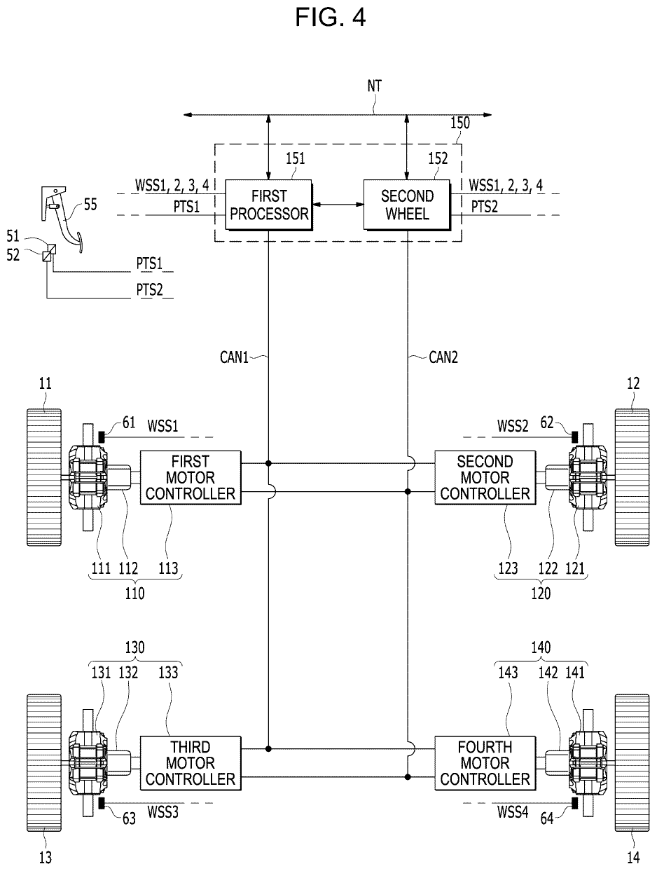

With reference to FIG. 4, the plurality of brake modules 110, 120, 130, and 140 may respectively include brakes 111, 121, 131, and 141, brake motors 112, 122, 132, and 142, and motor controllers 113, 123, 133, and 143.

The first brake module 110 may include a first brake 111, a first brake motor 112, and a first motor controller 113, and the first brake 111, the first brake motor 112, and the first motor controller 113 may be integrated.

The second brake module 120 may include a second brake 121, a second brake motor 122, and a second motor controller 123, and the second brake 121, the second brake motor 122, and the second motor controller 123 may be integrated.

The third brake module 130 may include a third brake 131, a third brake motor 132, and a third motor controller 133, and the third brake 131, the third brake motor 132, and the third motor controller 133 may be integrated.

The fourth brake module 140 may include a fourth brake 141, a fourth brake motor 142, and a fourth motor controller 143, and the fourth brake 141, the fourth brake motor 142, and the fourth motor controller 143 may be integrated.

The brakes 111, 121, 131, and 141 may each include the pad plates configured to brake each of the wheels 11, 12, 13, and 14 by coming into contact with the brake disc DISC configured to rotate together with each of the wheels 11, 12, 13, and 14. The plurality of brakes 111, 121, 131, and 141 may include the first to fourth brakes 111, 121, 131, and 141.

The brake motors 112, 122, 132, and 142 may each be an actuator and each provide torque for moving the pair of pad plates so that the pair of pad plates come into contact with the brake disc DISC. The rotation of each of the brake motors 112, 122, 132, and 142 may be converted into a linear movement by means of the spindle, and the pad plates may be brought into contact with the brake disc DISC by the linear movement of the piston.

The motor controllers 113, 123, 133, and 143 may each control a drive current for rotating each of the brake motors 112, 122, 132, and 142 in response to a braking signal from the controller 150. For example, the motor controllers 113, 123, 133, and 143 may each include an H bridge inverter or a three-phase inverter depending on each of the types of brake motors 112, 122, 132, and 142. In addition, the motor controllers 113, 123, 133, and 143 may each include a driving processor, such as an electronic controller (ECU), configured to receive braking signals from processors 151 and 152 of the controller 150 and control the H bridge inverter or the three-phase inverter to control the drive current of each of the brake motors 112, 122, 132, and 142 in response to the braking signal.

The controller 150 may receive output signals from the pedal sensor 50, the wheel speed sensor 60, the motion sensor 70, and/or the steering sensor 80 and control the operations of the plurality of brake modules 110, 120, 130, and 140.

The controller 150 may include the processors 151 and 152 configured to press the output signals from the pedal sensor 50, the wheel speed sensor 60, the motion sensor 70, and/or the steering sensor 80 and output electrical signals, which correspond to a service brake, an EBD, an ABS, a TSC, an ESC, an EPB, and the like, to the plurality of brake modules 110, 120, 130, and 140.

The controller 150 may include a plurality of processors 151 and 152 to prepare for damage to or errors of an electric system. For example, the controller 150 may preliminarily include a first processor 151 and a second processor 152. The second processor 152 may not be an essential component and may be excluded.

The first processor 151 may be separated from the plurality of brake modules 110, 120, 130, and 140 or integrated with any one of the plurality of brake modules 110, 120, 130, and 140.

The first processor 151 may control all the plurality of brake modules 110, 120, 130, and 140 or control only some of the plurality of brake modules 110, 120, 130, and 140. For example, during a normal operation, the first processor 151 integrated with the first brake module 110 may control all the plurality of brake modules 110, 120, 130, and 140.

The first processor 151 may process the output signals from the pedal sensor 50, the wheel speed sensor 60, the motion sensor 70, and/or the steering sensor 80. The first processor 151 may identify braking torque (or braking force, braking acceleration (deceleration), fastening force (clamping force)), which corresponds to the service brake, the EBD, the ABS, the TSC, the ESC, the EPB, and the like, based on the result of processing the output signals and output braking signals, which correspond to the braking torque, to all or some of the plurality of brake modules 110, 120, 130, and 140. The plurality of brake modules 110, 120, 130, and 140, which receive the braking signals, may brake the plurality of wheels 11, 12, 13, and 14 in accordance with the braking forces corresponding to the braking signals.

The first processor 151 may receive a first pedal signal PTS1 from a first pedal sensor 51 and receive first, second, third, and fourth wheel speed signals WSS1, WSS2, WSS3, and WSS4 from first, second, third, and fourth wheel speed sensors 41, 42, 43, and 44. In addition, the first processor 151 may be connected to the vehicle communication network NT. For example, the first processor 151 may receive a lateral acceleration signal and a yaw rate signal, which respectively represent a lateral acceleration and a yaw rate of the vehicle 1, from the motion sensor 70 through the vehicle communication network NT and receive a steering angle signal, which represents a steering angle of the vehicle 1, from the steering sensor 80.

The first processor 151 may be connected to the first, second, third, and fourth motor controllers 113, 123, 133, and 143 through a first communication network CAN1 and communicate with the plurality of motor controllers 113, 123, 133, and 143. In addition, the first processor 151 may be connected to the first, second, third, and fourth motor controllers 113, 123, 133, and 143 through the first communication network CAN1.

For example, the first communication network CAN1 may be an independent exclusive communication network separated from the vehicle communication network NT. Because the first communication network CAN1 is independently separated from the vehicle communication network NT, the braking signal generated by the first processor 151 may be more quickly transmitted to the first, second, third, and fourth brake modules 110, 120, 130, and 140, and the first, second, third, and fourth brake modules 110, 120, 130, and 140 may more quickly brake the plurality of wheels 11, 12, 13, and 14. The first communication network CAN1 may use various communication methods such as Ethernet, media-oriented system transport (MOST), Flexray, controller area network (CAN), and local interconnect network (LIN).

The first processor 151 may provide each of the first, second, third, and fourth brake modules 110, 120, 130, and 140 with a braking signal that represents braking torque (or braking force, braking acceleration (deceleration), or fastening force (clamping force)) for each wheel. For example, the first processor 151 may identify the braking torque required by the driver in response to the first pedal signal PTS1 and distribute the braking torque for the respective wheels to the first, second, third, and fourth brake modules 110, 120, 130, and 140 based on the braking torque required by the driver.

The first processor 151 may identify a slip and/or spin of the first, second, third, or fourth wheels 11, 12, 13, or 14 in response to each of the first, second, third, and fourth wheel speed signals WSS1, WSS2, WSS3, and WSS4 and control each of the first, second, third, and fourth brake modules 110, 120, 130, and 140 based on the slip and/or the spin of the first, second, third, or fourth wheels 11, 12, 13, or 14.

Based on the driver's parking instruction, the first processor 151 may transmit a parking signal for engaging or disengaging a parking brake to the third and fourth brake modules 130 and 140.

As described above, the first processor 151 may provide each of the first, second, third, and fourth brake modules 110, 120, 130, and 140 with a control signal for the EBD, the ABS, the TSC, the ESC, and the EPB.

The first processor 151 may communicate with the second processor 152. For example, the first processor 151 may periodically transmit an electrical signal to the second processor 152. The second processor 152 may identify an operating state (e.g., a normal state or a failure state) of the first processor 151 based on whether the first processor 151 receives the periodic status signal. In addition, the first processor 151 may periodically receive an electrical signal from the second processor 152. The first processor 151 may identify the normal state of the second processor 152 based on the second processor 152 receives the periodic status signal. The first processor 151 may identify the failure state (e.g., damage, error, reset, power cut off, or the like) of the second processor 152 based on the second processor 152 stops receiving the periodic status signal.

The second processor 152 may be separated from the plurality of brake modules 110, 120, 130, and 140 or integrated with another of the plurality of brake modules 110, 120, 130, and 140.

The second processor 152 may control all the plurality of brake modules 110, 120, 130, and 140 or control only some of the plurality of brake modules 110, 120, 130, and 140. For example, the second processor 152 integrated with the second brake module 120 may control all the plurality of brake modules 110, 120, 130, and 140 while the first processor 151 fails.

The second processor 152 may process the output signals from the pedal sensor 50, the wheel speed sensor 60, the motion sensor 70, and/or the steering sensor 80, identify the braking forces, which correspond to the service brake, the EBD, the ABS, the TSC, the ESC, the EPB, and the like, based on the result of processing the output signals, and output the braking signals, which correspond to the braking forces, to all or some of the plurality of brake modules 110, 120, 130, and 140. The plurality of brake modules 110, 120, 130, and 140, which receive the braking signals, may brake the plurality of wheels 11, 12, 13, and 14 in accordance with the braking forces corresponding to the braking signals.

The second processor 152 may receive a second pedal signal PTS2 from a second pedal sensor 52 and receive the wheel speed signals WSS1, WSS2, WSS3, and WSS4 from the wheel speed sensors 41, 42, 43, and 44. In addition, the second processor 152 may be connected to the vehicle communication network NT independently of the first processor 151. For example, the second processor 152 may receive a yaw rate signal, which represents a yaw rate of the vehicle 1, from the motion sensor 70 through the vehicle communication network NT and receive the steering angle signal, which represents the steering angle of the vehicle 1, from the steering sensor 80.

The second processor 152 may be connected to the plurality of motor controllers 113, 123, 133, and 143 through a second communication network CAN2 and communicate with the plurality of motor controllers 113, 123, 133, and 143 through the second communication network CAN2. For example, the second communication network CAN2 may be an independent exclusive communication network separated from the vehicle communication network NT and the first communication network CAN1. The second communication network CAN2 may use various communication methods such as Ethernet, media-oriented system transport (MOST), Flexray, controller area network (CAN), and local interconnect network (LIN). In addition, the second processor 152 may be connected to the first, second, third, and fourth motor controllers 113, 123, 133, and 143 through the second communication network CAN2.

For example, the second communication network CAN2 may be an independent exclusive communication network separated from the vehicle communication network NT and the first communication network CAN1. Because the second communication network CAN2 is independently separated from the vehicle communication network NT and the first communication network CAN1, the braking signal generated by the second processor 152 may be more quickly transmitted to the plurality of motor controllers 113, 123, 133, and 143, and the plurality of brake modules 110, 120, 130, and 140 may more quickly brake the plurality of wheels 11, 12, 13, and 14. The second communication network CAN2 may use various communication methods such as Ethernet, media-oriented system transport (MOST), Flexray, controller area network (CAN), and local interconnect network (LIN).

The second processor 152 may provide each of the first, second, third, and fourth brake modules 110, 120, 130, and 140 with the braking signal that represents braking torque (or braking force, braking acceleration (deceleration), or fastening force (clamping force)). For example, the second processor 152 may identify the braking torque required by the driver in response to the second pedal signal PTS2 and distribute the braking torque required by the driver to the first, second, third, and fourth brake modules 110, 120, 130, and 140.

The second processor 152 may identify a slip and/or spin of the first, second, third, or fourth wheels 11, 12, 13, or 14 in response to each of the first, second, third, and fourth wheel speed signals WSS1, WSS2, WSS3, and WSS4 and control each of the first, second, third, and fourth brake modules 110, 120, 130, and 140 based on the slip and/or the spin of the first, second, third, or fourth wheels 11, 12, 13, or 14.

Based on the driver's parking instruction, the second processor 152 may transmit a parking signal for engaging or disengaging a parking brake to the third and fourth brake modules 130 and 140.

As described above, the second processor 152 may provide each of the first, second, third, and fourth brake modules 110, 120, 130, and 140 with a control signal for the EBD, the ABS, the TSC, the ESC, and the EPB.

The second processor 152 may communicate with the first processor 151. For example, the second processor 152 may periodically transmit an electrical signal to the first processor 151. The first processor 151 may identify an operating state (e.g., a normal state or a failure state) of the second processor 152 based on whether the second processor 152 receives the periodic status signal. In addition, the second processor 152 may periodically receive an electrical signal from the first processor 151. The second processor 152 may identify the normal state of the first processor 151 based on the first processor 151 receives the periodic status signal. The second processor 152 may identify the failure state of the first processor 151 based on the first processor 151 stops receiving the periodic status signal.

The second processor 152 may be implemented by semiconductor elements provided separately from the first processor 151. Alternatively, the second processor 152 may be implemented by processing cores provided in a region separated from the first processor 151 in one semiconductor element.

The second processor 152 may have the same computation ability as the first processor 151 or have a lower computation ability than the first processor 151. For example, the number of instructions processed by the second processor 152 per unit time may be equal to or smaller than the number of instructions processed by the first processor 151 per unit time.

As described above, the controller 150 may include the first processor 151 and the second processor 152. Therefore, the second processor 152 may control the plurality of brake modules 110, 120, 130, and 140 when the first processor 151 fails. In addition, the first processor 151 may control the plurality of brake modules 110, 120, 130, and 140 when the second processor 152 fails.

For example, the brake pedal 55 may be provided at a lower side of a cabin so that the driver may control the brake pedal 55 with his/her foot. The driver may push the brake pedal 55 in accordance with a braking intention to brake the vehicle 1. In accordance with the driver's braking intention, the brake pedal 55 may depart from a reference position and move.

The pedal sensor 50 may be installed in the vicinity of the brake pedal 55 and measure the movement of the brake pedal 55 made by the driver's braking intention. For example, the pedal sensor 50 may detect a movement distance and/or a movement speed of the brake pedal 55 from a reference position.

The pedal sensor 50 may be electrically connected to the brake apparatus 100 and provide an electrical signal to the brake apparatus 100. For example, the pedal sensor 50 may be connected directly to the brake apparatus 100 through a hard wire or connected to the brake apparatus 100 through a communication network. The pedal sensor 50 may provide the brake apparatus 100 with an electrical signal corresponding to the movement distance and/or the movement speed of the brake pedal 55. In addition, the pedal sensor 50 may be integrated with the brake apparatus 100.

The pedal sensor 50 may include a plurality of pedal sensors in order to prepare for damage to or errors of the electric system. For example, the pedal sensor 50 may include a first sensor and a second sensor. The first and second sensors may each provide the brake apparatus 100 with an electrical signal corresponding to the movement distance and/or the movement speed of the brake pedal 55.

With reference to FIG. 4, the pedal sensor 50 may include the first pedal sensor 51 and the second pedal sensor 52. The first pedal sensor 51 and the second pedal sensor 52 may each detect a movement of the brake pedal 55 and provide each of the first processor 151 and the second processor 152 with the electrical output signals PTS1 and PTS2 corresponding to the movement (e.g., a movement displacement and/or a movement speed) of the brake pedal 55. For example, the first pedal sensor 51 may be electrically connected to the first processor 151 and provide the first pedal signal PTS1 to the first processor 151. The second pedal sensor 52 may be electrically connected to the second processor 152 and provide the second pedal signal PTS2 to the second processor 152.

The wheel speed sensor 60 may include a plurality of wheel speed sensors 61, 62, 63, and 64 respectively installed in the plurality of wheels 11, 12, 13, and 14. The plurality of wheel speed sensors 61, 62, 63, and 64 may independently detect the rotational speeds of the plurality of wheels 11, 12, 13, and 14.

The wheel speed sensor 60 may be electrically connected to the brake apparatus 100 and provide an electrical signal to the brake apparatus 100. For example, the plurality of wheel speed sensors may each be connected directly to the brake apparatus 100 through a hard wire or connected to the brake apparatus 100 through a communication network. The plurality of wheel speed sensors may each provide the brake apparatus 100 with an electrical signal corresponding to the rotational speed of each of the plurality of wheels 11, 12, 13, and 14.

The plurality of wheel speed sensors respectively installed in the plurality of wheels 11, 12, 13, and 14 may each include a plurality of sensors to prepare for damage to or errors of the electric system. For example, the plurality of wheel speed sensors may each include a first sensor and a second sensor. The first sensor and the second sensor may each provide the brake apparatus 100 with an electrical signal corresponding to the rotational speed of one of the plurality of wheels 11, 12, 13, and 14.

As illustrated in FIG. 4, the wheel speed sensor 60 may include a first wheel speed sensor 61, a second wheel speed sensor 62, a third wheel speed sensor 63, and a fourth wheel speed sensor 64. The wheel speed sensors 41, 42, 43, and 44 may provide the first processor 151 and the second processor 152 with the electrical output signals WSS1, WSS2, WSS3, and WSS4 corresponding to the rotational speeds of the plurality of wheels 11, 12, 13, and 14.

For example, the first wheel speed sensor 61 may provide the first processor 151 and the second processor 152 with a first wheel speed signal WSS1 corresponding to the rotational speed of the first wheel 11, and the second wheel speed sensor 62 may provide the first processor 151 and the second processor 152 with a second wheel speed signal WSS2 corresponding to the rotational speed of the second wheel 12. The third wheel speed sensor 63 may provide the first processor 151 and the second processor 152 with a third wheel speed signal WSS3 corresponding to the rotational speed of the third wheel 13, and the fourth wheel speed sensor 64 may provide the first processor 151 and the second processor 152 with a fourth wheel speed signal WSS4 corresponding to the rotational speed of the fourth wheel 14. In other words, the first processor 151 and the second processor 152 may acquire the wheel speed signals WSS1, WSS2, WSS3, and WSS4 from the first, second, third, and fourth wheel speed sensors 41, 42, 43, and 44.

The motion sensor 70 may be installed at an approximate center of the vehicle 1 and include an acceleration sensor and a gyro sensor that may detect a linear movement and a rotational movement of the vehicle 1. The acceleration sensor may detect linear movements of the vehicle 1 and the motion sensor 70. For example, the acceleration sensor may measure an acceleration, a speed, a movement displacement, a movement direction, and the like of the vehicle 1 while the vehicle 1 linearly moves. The gyro sensor may detect rotational movements of the vehicle 1 and the motion sensor 70. For example, the gyro sensor may measure an angular acceleration, an angular velocity, a rotational displacement, and/or the like of the vehicle 1 while the vehicle 1 performs a rotational movement.

The motion sensor 70 may detect a yaw rate indicating a rotation of the vehicle 1 about an axis perpendicular to a ground surface on which the vehicle 1 travels.

The motion sensor 70 may be electrically connected to the brake apparatus 100 and provide the brake apparatus 100 with an electrical signal indicating the linear movement and the rotational movement of the vehicle 1. The motion sensor 70 may be connected directly to the brake apparatus 100 through a hard wire or connected to the brake apparatus 100 through a communication network. The motion sensor 70 may provide the brake apparatus 100 with an electrical signal corresponding to the yaw rate of the vehicle 1.

For example, the steering wheel 85 may be provided forward of a driver seat so that the driver may control the steering wheel 85 with his/her hand. The driver may rotate the steering wheel 85 in accordance with a steering intention to steer the vehicle 1. The steering wheel 85 may rotate clockwise or counterclockwise in accordance with the driver's steering intention.

The steering sensor 80 may be installed in the vicinity of a column connected to the steering wheel 85 and measure the rotation of the steering wheel 85 implemented in accordance with the driver's steering intention. For example, the steering sensor 80 may detect an angle by which the steering wheel 85 rotates from a reference rotation position.

The steering sensor 80 may be electrically connected to the brake apparatus 100 and provide an electrical signal to the brake apparatus 100. For example, the steering sensor 80 may be connected directly to the brake apparatus 100 through a hard wire or connected to the brake apparatus 100 through a communication network. In addition, the steering sensor 80 may provide the brake apparatus 100 with an electrical signal corresponding to a rotation angle and/or torque of the steering wheel 85.

As described above, the brake apparatus 100 may include the plurality of brake modules 110, 120, 130, and 140 and the controller 150. The plurality of brake modules 110, 120, 130, and 140 may each be operated in response to a braking signal outputted only from the controller 150 without being mechanically or fluidly connected to the brake pedal 55.

As described above, because the brake pedal 55 and the plurality of brake modules 110, 120, 130, and 140 are not mechanically or fluidly connected, a configuration for coping with failures of the plurality of brake modules 110, 120, 130, and 140 or a failure of the controller 150 to ensure stability is provided.

For example, the controller 150 may include the first processor 151 and further include the second processor 152 in order to prepare for a failure of the first processor 151.

In addition, a countermeasure strategy may be provided to prepare for failures of the plurality of brake modules 110, 120, 130, and 140.

Various failures may occur on the plurality of brake modules 110, 120, 130, and 140. For example, the plurality of brakes 111, 121, 131, and 141 may fail. Mechanical failures, such as damage, may occur on the pad plates, the caliper housing, the piston, the cylinder part, the spindle, the nut, or the like included in each of the plurality of brakes 111, 121, 131, and 141. Electrical failures, such as disconnection of windings or short circuits in windings, or mechanical failures, such as damage to bearings, may occur on the plurality of brake motors 112, 122, 132, and 142. Electrical failures, such as damage to switching elements and short circuits and disconnection in the switching elements, may occur on the plurality of motor controllers 113, 123, 133, and 143. In addition, an electrical failure, such as a cut-off of a supply of electric power, may occur on the plurality of brake modules 110, 120, 130, and 140.

A failure may occur on at least one of the plurality of brake modules 110, 120, 130, and 140. For example, a failure may occur on the first brake module 110 related to the first wheel 11, a failure may occur on the second brake module 120 related to the second wheel 12, a failure may occur on the third brake module 130 related to the third wheel 13, or a failure may occur on the fourth brake module 140 related to the fourth wheel 14.

With reference back to FIG. 1, the controller 300 may control the process of braking the vehicle 1 in response to a signal received from the sensor part 200 provided in the vehicle.

The controller 300 may identify braking torque required by the driver based on an output signal from the sensor part 200 and set target braking torque for each wheel based on the braking torque required by the driver. For example, the controller 150 may identify the braking torque required by the driver based on a pedal signal received from the pedal sensor 50. In this case, the controller 150 may set the target braking torque for each wheel based on a large value between the braking torque required by the driver and an ADAS-required braking torque according to an advanced driver assistance system (ADAS) function.

The controller 150 may control the braking torque of each of the plurality of brake modules 110, 120, 130, and 140 based on the target braking torque for each wheel.

The controller 150 may identify failures of the plurality of brake modules 110, 120, 130, and 140 by using various means.

For example, the controller 150 may identify failures of the plurality of brake modules 110, 120, 130, and 140 based on communication signals of the plurality of motor controllers 113, 123, 133, and 143. The plurality of motor controllers 113, 123, 133, and 143 may each include a position sensor configured to detect a rotation of each of the plurality of brake motors 112, 122, 132, and 142, and an electric current sensor configured to detect a drive current of each of the plurality of brake motors 112, 122, 132, and 142. The plurality of motor controllers 113, 123, 133, and 143 may identify a failure of at least one of the plurality of brakes 111, 121, 131, and 141, the plurality of brake motors 112, 122, 132, and 142, and the plurality of motor controllers 113, 123, 133, and 143 based on outputs of the position sensors and/or outputs of the electric current sensors. The plurality of motor controllers 113, 123, 133, and 143 may transfer information on the failure of the brake module to the controller 150 in response to the failure of at least one of the plurality of brakes 111, 121, 131, and 141, the plurality of brake motors 112, 122, 132, and 142, and the plurality of motor controllers 113, 123, 133, and 143.

As another example, the controller 150 may identify failures of the plurality of brake modules 110, 120, 130, and 140 based on response signals of the plurality of motor controllers 113, 123, 133, and 143. The controller 150 may request responses from the plurality of motor controllers 113, 123, 133, and 143 and identify failures of the plurality of motor controllers 113, 123, 133, and 143 based on whether the response signals are received from the plurality of motor controllers 113, 123, 133, and 143.

As another example, the controller 150 may transmit braking signals to the plurality of brake modules 110, 120, 130, and 140 and identify failures of the plurality of brake modules 110, 120, 130, and 140 based on the output signal from the wheel speed sensor 60.

When a failure of at least one of the plurality of brake modules 110, 120, 130, and 140 is identified, the controller 150 may identify the occurrence of a yaw rate error between a current yaw rate and a target yaw rate of the vehicle 1 based on the output signal from the sensor part 90. For example, the controller 150 may identify a reference route of the vehicle 1 based on an output signal (e.g., a steering angle signal) of the steering sensor 80 while the vehicle 1 is steered, and the controller 150 may identify the target yaw rate of the vehicle 1 based on the reference route. In addition, the controller 150 may identify a traveling route of the vehicle 1 based on an output signal (e.g., a yaw rate signal) of the motion sensor 70 and identify the current yaw rate of the vehicle 1 based on the traveling route.

The controller 150 may identify the occurrence of a yaw rate error based on a difference between the target yaw rate and the current yaw rate and identify oversteering or understeering of the vehicle 1 based on the yaw rate error. For example, the controller 150 may identify oversteering or understeering based on a difference between the reference route and the traveling route, i.e., a difference between the driver's steering intention (target yaw rate) and the motion of the vehicle 1 (current yaw rate) while the vehicle 1 travels.

The controller 150 may perform signal processing using a low-pass filter to remove high-frequency noise and/or unnecessary rapid fluctuation from the yaw rate error.

The controller 150 may identify braking force (redistribution braking torque), which is required to be redistributed, based on the yaw rate error. For example, the controller 150 may calculate the redistribution braking torque by multiplying the signal-processed yaw rate error by a PID gain (proportional (P), integral (I), and differential (D)).

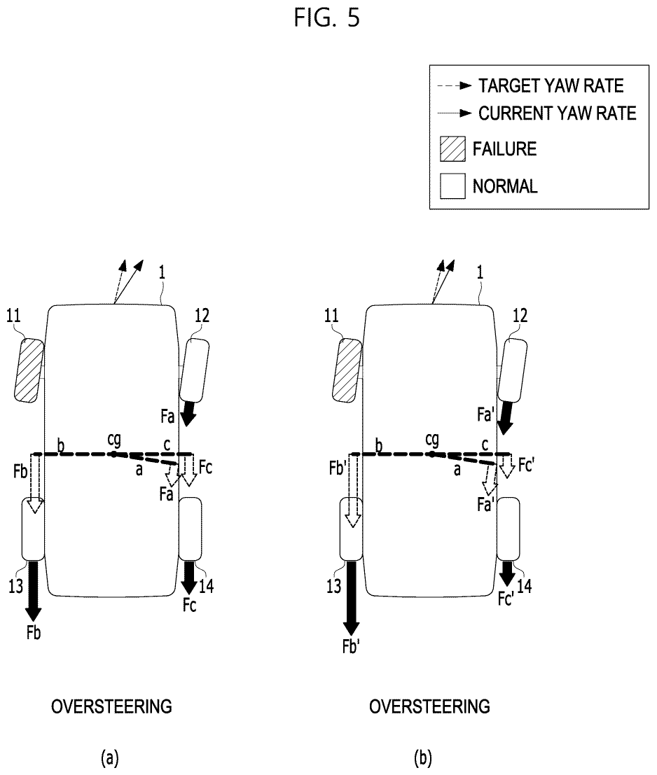

In addition, the controller 150 may acquire the additional braking torque for each wheel by acquiring the redistribution braking torque based on the target braking torque for each wheel and the brake modules 110, 120, 130, and 140 having failures, comparing moment-arms for an operational brake module based on an additional braking torque distribution variable, and distributing the redistribution braking torque based on the result of comparing the moment-arms. The operational brake module refers to a brake module that is capable of generating braking force in accordance with instructions from a controller, without any mechanical failure, electrical failure, or power supply interruption. Specifically, the operational brake module constitutes a brake module that is in a normal operational state and can respond properly to braking signals from the controller 150 to generate target braking torque. For example, as illustrated in FIG. 5, the operational brake module is indicated by the designation “NORMAL”.

(a) of FIG. 5 illustrates the vehicle 1 to which the target braking torque for each wheel is applied based on a failure of the first wheel and a right turn and oversteering of the vehicle are identified, and (b) of FIG. 5 illustrates the vehicle 1 to which total braking torque for each wheel is applied as the additional braking torque for each wheel is distributed in (a) of FIG. 5.

With reference to FIG. 5, when the right turn and oversteering of the vehicle are identified based on a failure of the brake module provided in the left wheel (the first wheel 11) on the first axle (front wheel) is identified, the controller 150 may reduce the yaw rate error, as illustrated in (b) of FIG. 5, by distributing the additional braking torque for each wheel of the brake modules 110, 120, 130, and 140 provided in the right wheel (the second wheel 12) on the first axle and the left wheel (the third wheel 13) on the second axle, the additional braking torque being greater than the additional braking torque for each wheel of the brake modules 110, 120, 130, and 140 provided in the right wheel (the fourth wheel 14) on the second axle.

In this case, first to third moment-arms a, b, and c and first to third forces Fa, Fb, and Fc are applied to the second wheel 12, the third wheel 13, and the fourth wheel 14 based on the yaw rate error, and the total braking torque for each wheel may be determined by setting the additional braking torque for each wheel by dividing the redistribution braking torque by comparing the first to third moment-arms a, b, and c. That is, the total braking torque for each wheel may be set as a sum of the target braking torque for each wheel and the additional braking torque for each wheel.

The first to third moment-arms a, b, and c may be components that induce the rotation of braking torque generated in the second wheel 12, the third wheel 13, and the fourth wheel 14 from center of gravity (cg) of the vehicle 1.

In (b) of FIG. 5, first to third moment-arms a, b, and c and first to third forces Fa′, Fb′, and Fc′ may be respectively applied to the second wheel 12, the third wheel 13, and the fourth wheel 14, and the first to third forces Fa′, Fb′, and Fc′ may determine the total braking torque for each wheel made by distributing the additional braking torque for each wheel.

As illustrated in (b) FIG. 5, when the braking torque of the plurality of brake modules 110, 120, 130, and 140 is controlled as the total braking torque for each wheel by distributing the additional braking torque for each wheel, the positive (+) moment may be increased to maintain the yaw rate within an error tolerance range.

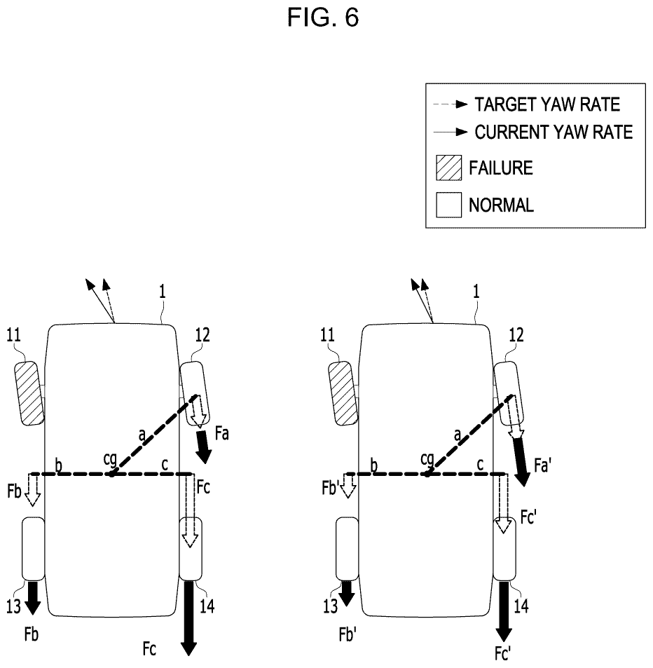

(a) of FIG. 6 illustrates the vehicle 1 to which the target braking torque for each wheel is applied based on a failure of the first wheel and a right turn and understeering of the vehicle are identified, and (b) of FIG. 6 illustrates the vehicle 1 to which total braking torque for each wheel is applied as the additional braking torque for each wheel is distributed in (a) of FIG. 5.

In this case, the description will be focused on a difference from FIG. 5 in order to avoid the repeated description.

With reference to FIG. 6, when the right turn and understeering of the vehicle 1 are identified based on failures of the brake modules 110, 120, 130, and 140 provided in the left wheel (the first wheel 11) on the first axle are identified, the controller 150 may reduce the yaw rate error by distributing the additional braking torque for each wheel of the brake modules 110, 120, 130, and 140 provided in the right wheel (the second wheel 12) on the first axle, the additional braking torque being greater than the additional braking torque for each wheel of the brake modules 110, 120, 130, and 140 provided in the left wheel (the third wheel 13) on the second axle and the right wheel (the fourth wheel 14) on the second axle.

As illustrated in (b) of FIG. 6, when the braking torque of the plurality of brake modules 110, 120, 130, and 140 is controlled as the total braking torque for each wheel by distributing the additional braking torque for each wheel, the negative (−) moment may be increased to maintain the yaw rate within an error tolerance range.

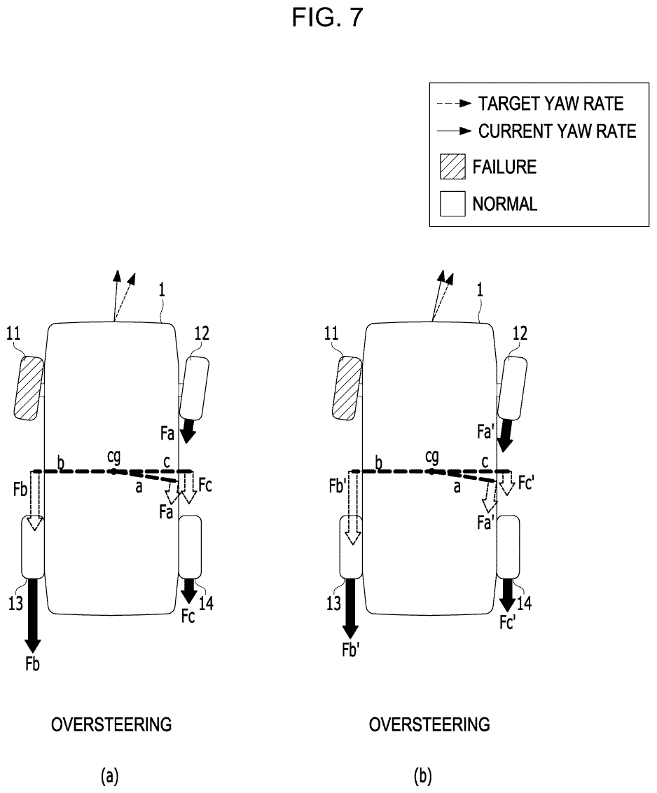

(a) of FIG. 7 illustrates the vehicle 1 to which the target braking torque for each wheel is applied based on a failure of the first wheel and a left turn and oversteering of the vehicle are identified, and (b) of FIG. 7 illustrates the vehicle 1 to which total braking torque for each wheel is applied as the additional braking torque for each wheel is distributed in (a) of FIG. 7.

In this case, the description will be focused on a difference from FIG. 5 in order to avoid the repeated description.

With reference to FIG. 7, when the left turn and oversteering of the vehicle 1 are identified based on failures of the brake modules 110, 120, 130, and 140 provided in the left wheel (the first wheel 11) on the first axle are identified, the controller 150 may reduce the yaw rate error by distributing the additional braking torque for each wheel of the brake modules provided in the right wheel (the second wheel 12) on the first axle, the additional braking torque being greater than the additional braking torque for each wheel of the brake modules provided in the left wheel (the third wheel 13) on the second axle and the right wheel (the fourth wheel 14) on the second axle.

As illustrated in (b) of FIG. 7, when the braking torque of the plurality of brake modules 110, 120, 130, and 140 is controlled as the total braking torque for each wheel by distributing the additional braking torque for each wheel, the negative (−) moment may be increased to maintain the yaw rate within an error tolerance range.

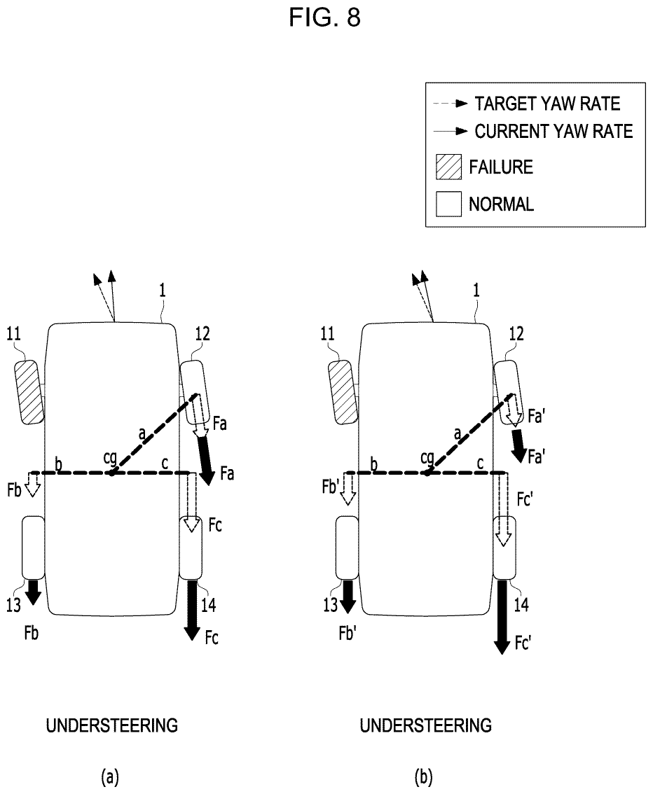

(a) of FIG. 8 illustrates the vehicle 1 to which the target braking torque for each wheel is applied based on a failure of the first wheel and the left turn and understeering of the vehicle are identified, and (b) of FIG. 8 illustrates the vehicle 1 to which total braking torque for each wheel is applied as the additional braking torque for each wheel is distributed in (a) of FIG. 8.

In this case, the description will be focused on a difference from FIG. 5 in order to avoid the repeated description.

With reference to FIG. 8, when the left turn and oversteering of the vehicle 1 are identified based on failures of the brake modules 110, 120, 130, and 140 provided in the left wheel (the first wheel 11) on the first axle are identified, the controller 150 may reduce the yaw rate error by distributing the additional braking torque for each wheel of the brake modules provided in the left wheel (the third wheel 13) on the second axle and the right wheel (the fourth wheel 14) on the second axle, the additional braking torque being greater than the additional braking torque for each wheel of the brake modules 110, 120, 130, and 140 provided in the right wheel (the second wheel 12) on the first axle.

As illustrated in (b) of FIG. 8, when the braking torque of the plurality of brake modules 110, 120, 130, and 140 is controlled as the total braking torque for each wheel by distributing the additional braking torque for each wheel, the positive (+) moment may be increased to maintain the yaw rate within an error tolerance range.

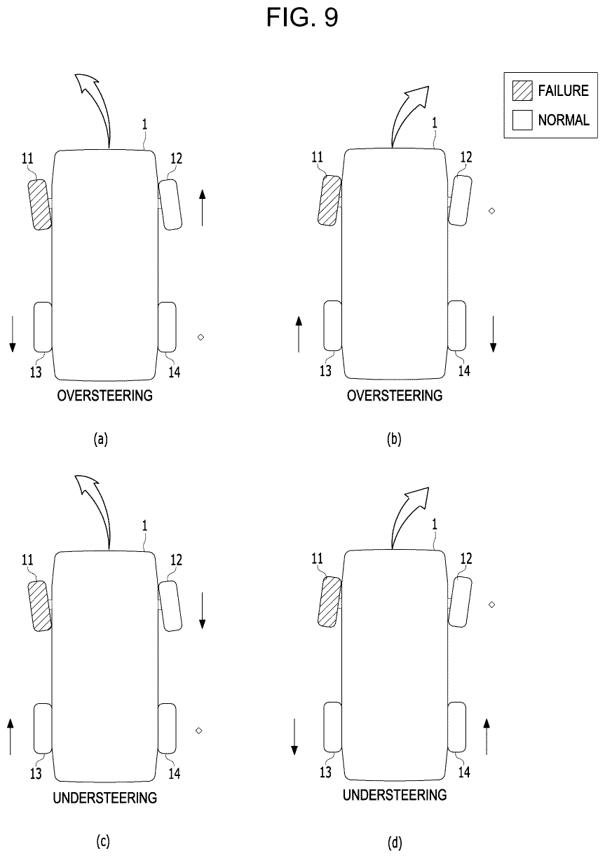

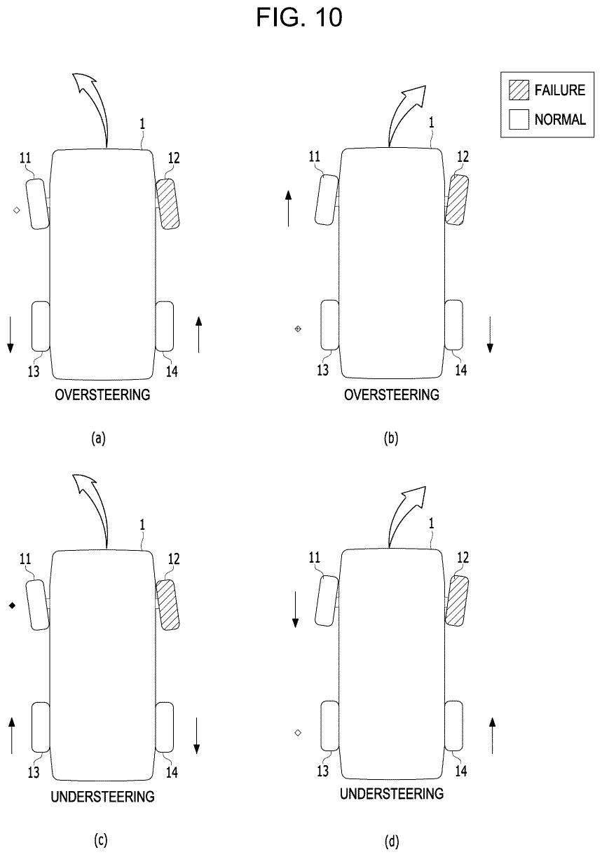

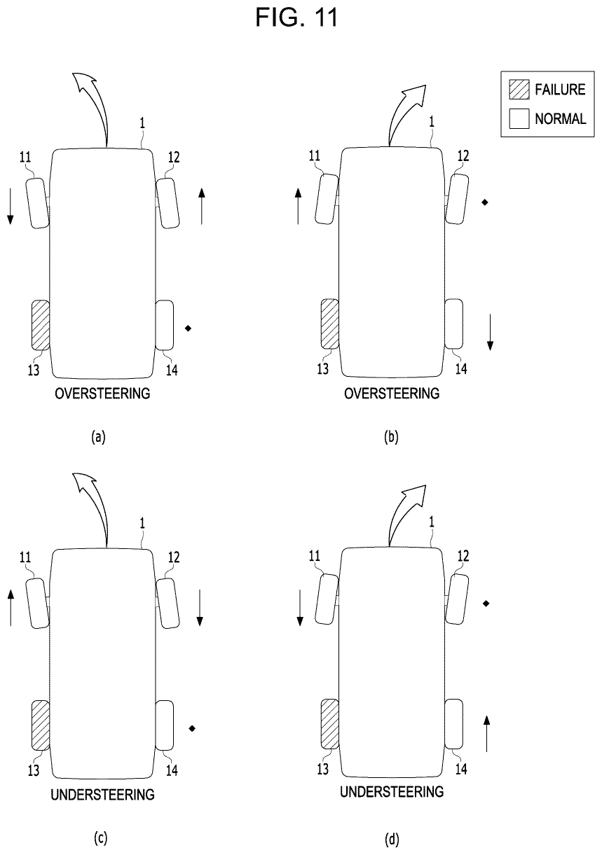

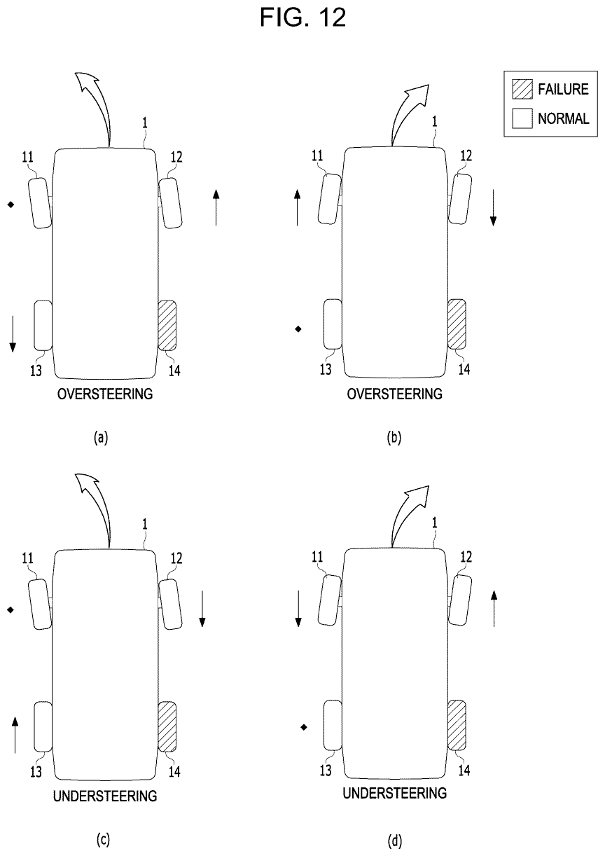

With reference to FIGS. 9 to 12, the controller 150 may identify the additional braking torque distribution variable including at least one of positions of the brake modules 110, 120, 130, and 140 having failures, a traveling direction of the vehicle 1, and a traveling motion of the vehicle 1 based on the yaw rate error. In this case, the positions of the brake modules 110, 120, 130, and 140 having failures may be identified as the left and right wheels. The traveling direction of the vehicle 1 may be identified as the left turn, the straight traveling, or the right turn. The traveling motion of the vehicle 1 may be identified as the oversteering or the understeering.

The controller 150 may assign a negative (−) or positive (+) first sign to each of the positions of the brake modules 110, 120, 130, and 140 having failures, the traveling direction of the vehicle 1, and the traveling motion of the vehicle 1. In addition, the controller 150 may assign a negative (−) or positive (+) second sign for the brake module on the same side as the failed brake module based on a computation of the assigned sign. In addition, the controller 150 may assign a negative (−) or positive (+) third sign to the brake modules 110, 120, 130, and 140 at the sides (e.g., the right wheels of the vehicle) opposite to the brake modules 110, 120, 130, and 140 having failures based on the computation of the second sign and the first sign assigned to the traveling motion. In addition, the controller 150 may distribute the additional braking torque for each wheel to the brake modules 110, 120, 130, and 140 having no failure based on the second sign and the third sign.

In this case, the controller 150 assigns the signs to efficiently distribute the additional braking torque for each wheel for control convenience.

The controller 150 may distribute the additional braking torque for each wheel, which is acquired by increasing or decreasing the redistribution braking torque, to the brake modules 110, 120, 130, and 140 on the same side (e.g., the left wheels of the vehicle) based on the second sign.

In addition, the controller 150 may distribute the additional braking torque for each wheel, which is acquired by increasing or decreasing the redistribution braking torque, to the brake modules 110, 120, 130, and 140 provided at the sides opposite to any one of the first axle (front wheel) and the second axle (rear wheel) based on the third sign.

In addition, the controller 150 may acquire the additional braking torque for each wheel distributed to the brake modules 110, 120, 130, and 140 having no failure based on the second sign and the third sign, and the controller 150 may distribute the additional braking torque for each wheel, which is acquired by increasing or decreasing the redistribution braking torque, to the brake modules 110, 120, 130, and 140 provided at the sides opposite to the remaining one of the first axle (front wheel) and the second axle (rear wheel) based on the third sign.

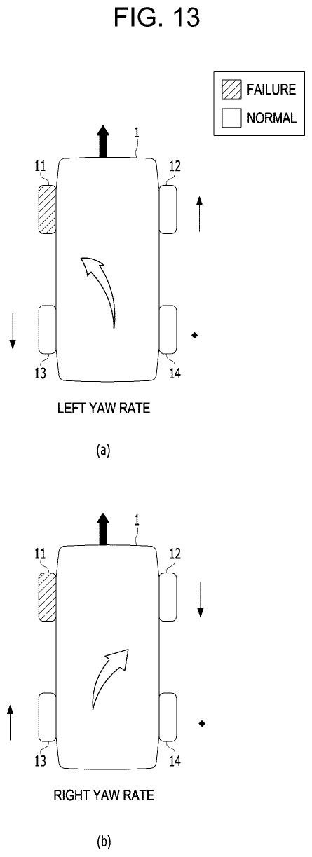

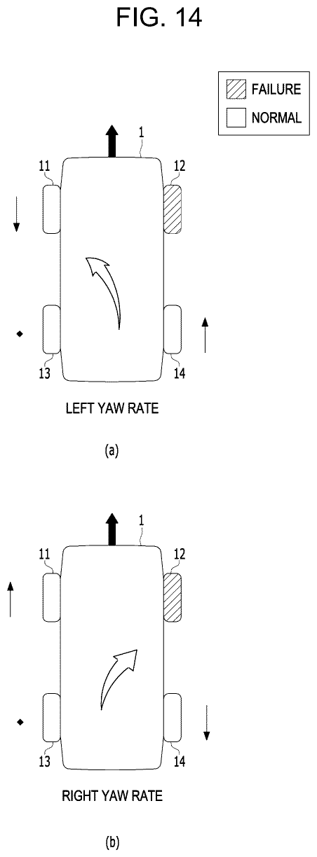

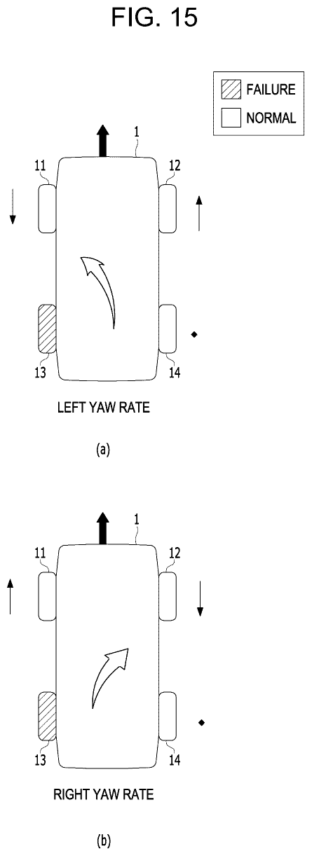

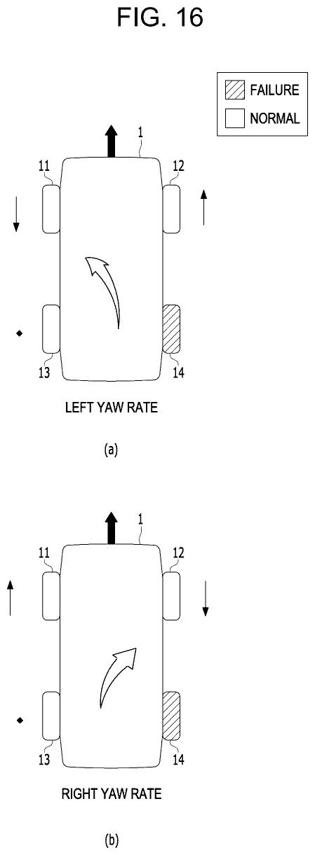

In FIGS. 9 to 16, the ascending arrow may be assign to a positive (+) sign and indicate an increase in redistribution braking torque, and the descending arrow may be assign to a negative (−) sign and indicate a decrease in redistribution braking torque.

For example, the first sign may be assign such that the left wheel may be assign to 1, the right wheel may be assign to −1, the left turn or straight traveling may be assign to −1, the right turn may be assign to 1, the oversteering may be assign to −1, and the understeering may be assign to 1.

Based on the computation of the first sign, the second sign may be assign such that in the brake module on the same side as the brake modules 110, 120, 130, and 140 having failures, the increase in redistribution braking torque may be assign to 1, and the decrease in redistribution braking torque may be assign to −1. In this case, the additional braking torque for each wheel, which is distributed to the brake modules 110, 120, 130, and 140 having no failure on the same side as the brake modules 110, 120, 130, and 140 having failures, may be set to [second sign*redistribution braking torque*ratio]. In this case, the ratio may be set as an addition distribution ratio that may vary depending on a degree of a slip and/or spin of the corresponding wheel.

Based on the computation of the second sign and the first sign (oversteering of −1 and understeering of 1) related to the vehicle motion, the third sign may be assign to −1 when a position at which the redistribution braking torque is distributed is the first axle (front wheel), and the third sign may be assign to 1 when the position at which the redistribution braking torque is distributed is the second axle (rear wheel). In this case, the additional braking torque for each wheel, which is distributed to the brake modules 110, 120, 130, and 140 having no failures of the first axle (front wheel) and the second axle (rear wheel) may be set to [−second sign*redistribution braking torque*ratio]. In this case, the ratio may be set as an addition distribution ratio that may vary depending on a degree of a slip and/or spin of the corresponding wheel.

For example, as illustrated in (a) of FIG. 9, the controller 150 identifies the second sign as −1 based on the computation of [left wheel 1*left turn (−1)*oversteering 1] and distribute the reduced redistribution braking torque to the brake modules 110, 120, 130, and 140 of the third wheel 13 having no failure on the same side as the brake modules 110, 120, 130, and 140 having failures, such that the controller 150 may perform the braking control by means of the total braking torque for each wheel with the reduced additional braking torque for each wheel in comparison with the brake modules 110, 120, 130, and 140 of the second wheel 12.

In addition, the controller 150 identifies the third sign as −1 based on the computation of [second sign (−1)*oversteering 1] and distribute the increased redistribution braking torque to the first axle (front wheel), i.e., the brake module of the second wheel 12 at a side different from the brake modules 110, 120, 130, and 140 having failures, such that the controller 150 may perform the braking control by means of the total braking torque for each wheel with the increased additional braking torque for each wheel in comparison with the brake modules 110, 120, 130, and 140 of the third wheel 13.

The controller 150 computes and identifies the second sign and the third sign in the above-mentioned way, such that the controller 150 may perform the braking control by means of the total braking torque for each wheel with the decreased or increased additional braking torque for each wheel in order to reduce the yaw rate error by distributing the decreased or increased redistribution braking torque to the brake modules 110, 120, 130, and 140 having no failures on the same side as and at the side different from the brake modules 110, 120, 130, and 140 having failures.

Therefore, the brake apparatus 100 according to the embodiment of the disclosed disclosure may stably stop the vehicle by preventing the vehicle from tilting in the braking situation when any one of the electromechanical brakes respectively provided in the plurality of wheels of the vehicle malfunctions.

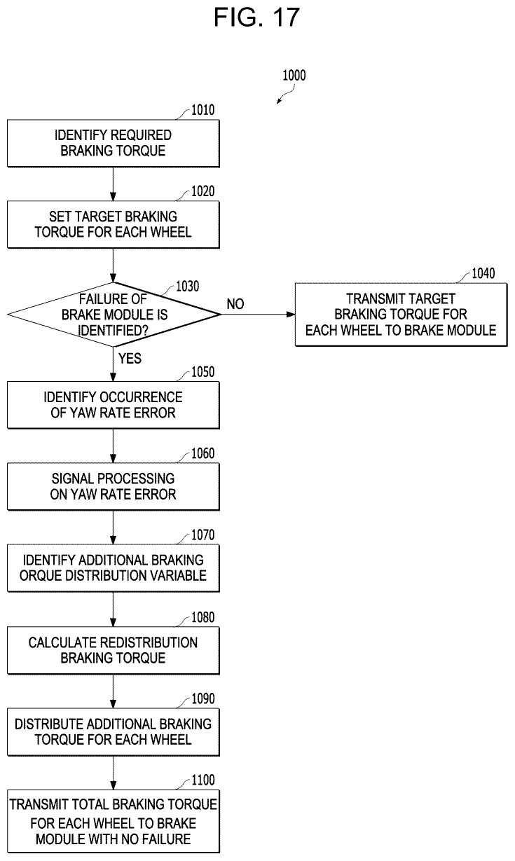

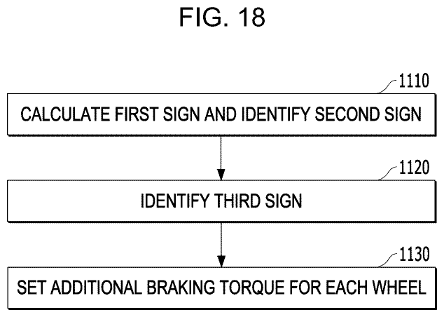

Hereinafter, a method of controlling the brake apparatus according to the embodiment of the disclosed disclosure will be described with reference to FIGS. 17 and 18. In this case, the control method will be described with reference to the brake apparatus according to the above-mentioned embodiment.

FIG. 17 is a view illustrating the method of controlling the brake apparatus according to the embodiment of the disclosed disclosure. FIG. 18 is a view illustrating detailed processes in FIG. 17.

With reference to FIGS. 17 and 18, according to a method 1000 of controlling the brake apparatus according to the embodiment, the controller 150 may identify the braking torque required by the driver based on the output signal from the sensor part 90 provided in the vehicle (1010) and set the target braking torque for each wheel for the plurality of brake modules 110, 120, 130, and 140 based on the required braking torque (1020).

When a failure of at least one of the plurality of brake modules 110, 120, 130, and 140 is identified (1030), the controller 150 may identify the occurrence of a yaw rate error between the current yaw rate and the target yaw rate of the vehicle based on the output signal from the sensor part 90 (1050). If a failure of at least one of the plurality of brake modules 110, 120, 130, and 140 is not identified, the braking control may be performed by transmitting the target braking torque for each wheel to the plurality of brake modules 110, 120, 130, and 140 (1040).

The controller 150 may perform signal processing using a low-pass filter to remove high-frequency noise and/or unnecessary rapid fluctuation from the yaw rate error (1060).

With reference to FIGS. 9 to 12, the controller 150 may identify the additional braking torque distribution variable including at least one of the positions of the brake modules having failures, the traveling direction of the vehicle, and the traveling motion of the vehicle based on the yaw rate error (1070).

The controller 150 may acquire the additional braking torque for each wheel by acquiring the redistribution braking torque based on the target braking torque for each wheel and the brake modules 110, 120, 130, and 140 having failures, comparing moment-arms for the operational brake module based on an additional braking torque distribution variable, and distributing the redistribution braking torque based on the result of comparing the moment-arms.

The controller 150 may distribute the additional braking torque for each wheel to the brake modules 110, 120, 130, and 140 having no failure based on the additional braking torque distribution variable (1090), and the controller 150 may control the braking torque of the brake modules 110, 120, 130, and 140 having no failure based on the target braking torque for each wheel and the additional braking torque for each wheel (1100).

Therefore, the method of controlling the brake apparatus according to the embodiment of the disclosed disclosure may stably stop the vehicle by preventing the vehicle from tilting in the braking situation when any one of the electromechanical brakes respectively provided in the plurality of wheels of the vehicle malfunctions. Therefore, it is possible to stably stop the vehicle by preventing the vehicle from tilting even in the situation in which the braking force of the wheel with a failure is maintained at a predetermined value.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

As described above, the embodiments have been described with reference to the accompanying drawings. A person skilled in the art may understand that the present disclosure may be carried out in other forms different from those disclosed in the embodiments without changing the technical spirit or the essential features of the present disclosure. The disclosed embodiments are illustrative and should not be interpreted as being restrictive.

What is claimed is:

1. A brake apparatus comprising:
a plurality of brake modules respectively provided in left and right wheels on a first axle of a vehicle;
a plurality of brake modules respectively provided in left and right wheels on a second axle of the vehicle; and
a controller configured to:
set target braking torque for each wheel based on an output signal from a pedal sensor provided in the vehicle; and
control braking torque of each of the plurality of brake modules based on the target braking torque for each wheel,
wherein the controller is further configured to:
identify an occurrence of a yaw rate error between a target yaw rate and a current yaw rate of the vehicle, based on an output signal of a motion sensor provided in the vehicle upon identifying a failure of at least one of the plurality of brake modules;
distribute additional braking torque for each wheel to an operational brake module based on the yaw rate error; and
control braking torque of the operational brake module based on the target braking torque for each wheel and the additional braking torque for each wheel.

2. The brake apparatus of claim 1, wherein the controller is further configured to:
identify an additional braking torque distribution variable including at least one of a position of a failed brake module, where the failure is identified, a traveling direction of the vehicle, and a traveling motion of the vehicle; and
distribute the additional braking torque for each wheel to the operational brake module based on the additional braking torque distribution variable.

3. The brake apparatus of claim 2, wherein the controller is further configured to:
acquire the additional braking torque for each wheel by acquiring redistribution braking torque based on the target braking torque for each wheel and the failed brake module;
compare moment-arms for the operational brake module based on the additional braking torque distribution variable; and
distribute the redistribution braking torque based on a result of comparing of the moment-arms.

4. The brake apparatus of claim 3, wherein the controller is further configured to:
assign a negative (−) or positive (+) first sign to each of the position of the failed brake module, the traveling direction of the vehicle, and the traveling motion of the vehicle;
assign a negative (−) or positive (+) second sign to the brake module that is positioned on the same side of any one of the first axle and the second axle as the failed brake module, based on a computation of the assigned sign;
assign a negative (−) or positive (+) third sign to the brake module that is positioned on the opposite side of any one of the first axle and the second axle to the failed brake module, based on a computation of the second sign and the first sign assigned to the traveling motion; and
distribute the additional braking torque for each wheel to the operational brake module based on the second sign and the third sign.

5. The brake apparatus of claim 4, wherein the controller is further configured to distribute additional braking torque for each wheel, which is acquired by increasing or decreasing the redistribution braking torque, to the brake module that is positioned on the same side of any one of the first axle and the second axle as the failed brake module, based on the second sign.

6. The brake apparatus of claim 5, wherein the controller is further configured to distribute additional braking torque for each wheel, which is acquired by increasing or decreasing the redistribution braking torque, to the brake module that is positioned on the opposite side of any one of the first axle and the second axle to the failed brake module, based on the third sign.

7. The brake apparatus of claim 6, wherein the controller is further configured to:
acquire the additional braking torque for each wheel distributed to the operational brake module based on each of the second sign and the third sign; and
distribute the additional braking torque for each wheel, which is acquired by increasing or decreasing the redistribution braking torque, to the brake module that is positioned on the opposite side of the remaining one of the first axle and the second axle to the failed brake module.

8. The brake apparatus of claim 7, wherein the controller is further configured to:
assign a negative (−) and positive (+) sign to the left and right wheels identified based on the position of the failed brake module;
assign a negative (−) and positive (+) sign to left and right turns identified based on the traveling direction of the vehicle; and
assign a negative (−) and positive (+) sign to understeering and oversteering identified based on the traveling motion of the vehicle.

9. The brake apparatus of claim 3, wherein based on the identification of the failure in the brake module provided at the left wheel of the first axle, when a right turn and oversteering of the vehicle are identified, the controller is further configured to reduce the yaw rate error by distributing the additional braking torque for each wheel of the brake modules provided in the right wheel on the first axle and the left wheel on the second axle, and
wherein the additional braking torque is greater than the additional braking torque for each wheel of the brake module provided in the right wheel on the second axle.

10. The brake apparatus of claim 3, wherein based on the identification of the failure in the brake module provided at the left wheel of the first axle, when a right turn and understeering of the vehicle are identified, the controller is further configured to reduce the yaw rate error by distributing the additional braking torque for each wheel of the brake module provided in the right wheel on the second axle, and
wherein the additional braking torque is greater than the additional braking torque for each wheel of the brake modules provided in the right wheel on the first axle and the left wheel on the second axle.

11. The brake apparatus of claim 3, wherein based on the identification of the failure in the brake module provided at the left wheel of the first axle, when a left turn and oversteering of the vehicle are identified, the controller is further configured to reduce the yaw rate error by distributing the additional braking torque for each wheel of the brake module provided in the right wheel on the first axle, and
wherein the additional braking torque is greater than the additional braking torque for each wheel of the brake modules provided in the left wheel on the second axle and the right wheel on the second axle.

12. The brake apparatus of claim 3, wherein based on the identification of the failure in the brake module provided at the left wheel of the first axle, when a left turn and understeering of the vehicle are identified, the controller is further configured to reduce the yaw rate error by distributing the additional braking torque for each wheel of the brake modules provided in the left wheel on the second axle and the right wheel on the second axle, and
wherein the additional braking torque is greater than the additional braking torque for each wheel of the brake module provided in the right wheel on the first axle.

13. The brake apparatus of claim 3, wherein the controller is configured to set the target braking torque for each wheel based on a greater value of a required braking torque and an advanced driver assistance system (ADAS)-required braking torque determined by an ADAS function.

14. A method of controlling a brake apparatus, which comprises a plurality of brake modules related to braking of left and right wheels on a first axle of a vehicle, a plurality of brake modules related to braking of left and right wheels on a second axle of the vehicle, and a controller, the method comprising:
setting, by the controller, target braking torque for each wheel for the plurality of brake modules based on an output signal from a pedal sensor provided in the vehicle;
identifying, by the controller, an occurrence of a yaw rate error between a target yaw rate and a current yaw rate of the vehicle based on an output signal from a motion sensor provided in the vehicle upon identifying a failure of at least one of the plurality of brake modules is identified;
distributing, by the controller, additional braking torque for each wheel to the operational brake module based on the yaw rate error; and
controlling, by the controller, braking torque of the operational brake module based on the target braking torque for each wheel and the additional braking torque for each wheel.

15. The method of claim 14, wherein the distributing of the additional braking torque for each wheel to the brake module by the controller comprises:
identifying an additional braking torque distribution variable including at least one of a position of a failed brake module, where the failure is identified, a traveling direction of the vehicle, and a traveling motion of the vehicle; and
distributing the additional braking torque for each wheel to the operational brake module based on the additional braking torque distribution variable.

16. The method of claim 15, wherein the distributing of the additional braking torque for each wheel to the brake module by the controller further comprises:
acquiring the additional braking torque for each wheel by acquiring redistribution braking torque based on the target braking torque for each wheel and the failed brake module;
comparing moment-arms for the operational brake module based on the additional braking torque distribution variable; and
distributing the redistribution braking torque based on a result of comparing the moment-arms.

17. The method of claim 16, wherein the distributing of the additional braking torque for each wheel to the brake module by the controller further comprises:
assigning a negative (−) or positive (+) first sign to each of the position of the failed brake module, the traveling direction of the vehicle, and the traveling motion of the vehicle;
assigning a negative (−) or positive (+) second sign to the brake module that is positioned on the same side of any one of the first axle and the second axle as the failed brake module based on a computation of the assigned sign;
assigning a negative (−) or positive (+) third sign to the brake module that is positioned on the opposite side of any one of the first axle and the second axle to the failed brake module based on a computation of the second sign and the first sign assigned to the traveling motion; and
distributing the additional braking torque for each wheel to the operational brake module based on the second sign and the third sign.

18. The method of claim 17, wherein the distributing of the additional braking torque for each wheel to the brake module by the controller further comprises:
distributing the additional braking torque for each wheel, which is acquired by increasing or decreasing the redistribution braking torque, to the brake module that is positioned on the same side of any one of the first axle and the second axle as the failed brake module, based on the second sign.

19. The method of claim 17, wherein the distributing of the additional braking torque for each wheel to the brake module by the controller further comprises:
distributing the additional braking torque for each wheel, which is acquired by increasing or decreasing the redistribution braking torque, to the brake module that is positioned on the opposite side of any one of the first axle and the second axle to the failed brake module, based on the third sign.

20. The method of claim 17, wherein the distributing of the additional braking torque for each wheel to the brake module by the controller further comprises:
acquiring the additional braking torque for each wheel distributed to the operational brake module based on the second sign and the third sign; and
distributing the additional braking torque for each wheel, which is acquired by increasing or decreasing the redistribution braking torque, to the brake module that is positioned on the opposite side of the remaining one of the first axle and the second axle to the failed brake module.
